(19) United States
(12) Patent Application Publication
(10) Pub. No.: US 2026/0105197 A1
(43) Pub. Date: Apr. 16, 2026

(54) KEYBOARD SECURITY DEVICE AND KEYBOARD SECURITY METHOD

(71) Applicant: NUVOTON TECHNOLOGY CORPORATION, HSINCHU CITY (TW)

(72) Inventor: PAO-CHEN KO, zhubei City (TW)

(21) Appl. No.: 19/327,128

(22) Filed: Sep. 12, 2025

(30) Foreign Application Priority Data
Oct. 14, 2024 (TW) 113138975

(51) Int. Cl. G06F 21/83; G06F 3/023; G06F 3/16

(52) U.S. Cl. CPC G06F 21/83; G06F 3/023; G06F 3/162

(57) ABSTRACT

A keyboard security device includes a keyboard control module for outputting typing information when the keyboard is in use; an audio signal control module for outputting a first raw audio signal when a microphone module is activated; an intelligent learning module for generating an additional audio signal based on the typing information received from the keyboard control module and the first raw audio signal received from the audio signal control module, and outputting the additional audio signal; and a sound mixing module for, in response to a trigger signal, mixing a second raw audio signal received from the audio signal control module with the additional audio signal received from the intelligent learning module, to generate a mixed audio signal and output the mixed audio signal. The first raw audio signal corresponds to the typing information.

### CROSS-REFFERENCE TO RELATED APPLICATION

This application claims the priority from the TW Patent Application No. 113138975, filed on Oct. 14, 2024, and all contents of such TW Patent Application are comprised in the present disclosure.

### BACKGROUND OF THE DISCLOSURE

### 1. Field of the Disclosure

The present invention relates to an information security technology, and more specifically, to a keyboard security device and a keyboard security method.

### 2. Description of the Related Art

Today's electronic devices (such as desktop computers or laptops) are typically equipped with various input and output devices (such as keyboards and microphones) to support a wide range of applications (such as video conferencing).

When participating in video conferences, for the sake of immediacy and convenience, participants may use the keyboard while the microphone is on (i.e., typing while speaking). However, this usage scenario presents potential security risks. Specifically, by intercepting or stealing the audio recorded by the microphone, third parties (such as malicious individuals or software) could potentially use typing sounds to decipher sensitive information entered by the user (such as passwords or other private information).

### SUMMARY OF THE DISCLOSURE

To solve the above technical problem, the present disclosure proposes a keyboard security device and a keyboard security method to enhance the security of using the keyboard while the microphone is active.

An embodiment of the present disclosure provides a keyboard security device, comprising: a keyboard control module, connected to a keyboard, configured to output typing information when the keyboard is in use; an audio signal control module, connected to a microphone module, configured to output a first raw audio signal when the microphone module is activated; an intelligent learning module, connected to the keyboard control module and the audio signal control module, configured to: generate an additional audio signal based on the typing information received from the keyboard control module and the first raw audio signal received from the audio signal control module; and output the additional audio signal; and a mixing sound module, connected to the audio signal control module and the intelligent learning module, configured to: in response to a trigger signal, mix a second raw audio signal received from the audio signal control module with the additional audio signal received from the intelligent learning module to produce a mixed audio signal; and output the mixed audio signal, wherein: the first raw audio signal corresponds to the typing information.

An embodiment of the present disclosure provides another keyboard security device, applicable to a system including a keyboard, a keyboard control module, a microphone module, and an audio signal control module, wherein the keyboard control module is connected to the keyboard and outputs typing information when the keyboard is in use, the audio signal control module is connected to the microphone module and outputs a raw audio signal when the microphone module is activated, the raw audio signal corresponds to the typing information. The keyboard security device comprises: an intelligent learning module, connected to the keyboard control module and the audio signal control module, wherein the intelligent learning module is trained based on the first typing information output by the keyboard control module and the first raw audio signal output by the audio signal control module, and the trained intelligent learning module generates and outputs an additional audio signal based on the second typing information output by the keyboard control module; and a mixing sound module, connected to the audio signal control module and the intelligent learning module, configured to mix a second raw audio signal received from the audio signal control module with the additional audio signal received from the intelligent learning module to produce a mixed audio signal, wherein the second raw audio signal corresponds to the second typing information; and output the mixed audio signal.

An embodiment of the present disclosure further provides a keyboard security method, comprising: a keyboard security method applicable to a system including a keyboard, a keyboard control module, a microphone module, and an audio signal control module, wherein the keyboard control module is connected to the keyboard and configured to output typing information, the audio signal control module is connected to the microphone module, and the keyboard security method comprises: obtaining a first raw audio signal through the audio signal control module when the microphone module is activated; generating an additional audio signal based on the typing information and the first raw audio signal; in response to a trigger signal, mixing the additional audio signal with a second raw audio signal received from the audio signal control module to produce a mixed audio signal; and outputting the mixed audio signal, wherein the first raw audio signal corresponds to the typing information.

Based on the above, the keyboard security device and keyboard security method disclosed herein can enhance the security of keyboard usage when the microphone is turned on, i.e., reducing or eliminating the potential risk of third parties using typing sounds to crack sensitive information entered by the user.

### BRIEF DESCRIPTION OF THE DRAWINGS

The drawings provided are to enable a person having ordinary skill in the art to further understand the present disclosure, and are incorporated in and constitute a part of the specification of the present disclosure. The drawings illustrate exemplary embodiments of the present disclosure, and are used to explain the principle of the present disclosure along with the description in the specification.

FIG. 1 is a block diagram of a keyboard security device according to an embodiment of the present disclosure;

FIG. 2 is a block diagram of an intelligent learning module according to an embodiment of the present disclosure; and

FIG. 3 is a flow diagram of a keyboard security method according to an embodiment of the present disclosure.

### DESCRIPTION OF THE PREFERRED EMBODIMENTS

The present disclosure provides a keyboard security device and a keyboard security method to address the issues mentioned in the background. In order to clearly convey the features and advantages of the present disclosure, the specific embodiments of the invention will be described in detail with reference to the accompanying drawings. The following description includes specific information related to exemplary embodiments in this disclosure. The drawings and the accompanying detailed description of the present disclosure are only for illustrative exemplary embodiments and do not limit the disclosure. Those skilled in the art will consider other variations and implementations of the present disclosure. Unless otherwise indicated, identical or corresponding elements in the drawings are designated by the same or corresponding reference numbers. Additionally, the drawings in this disclosure are generally not drawn to scale and are not intended to represent actual relative dimensions.

The following disclosure provides multiple embodiments or examples to implement various features of the present disclosure. Specific examples of the arrangement of various components are described to simplify the explanation. These specific examples, however, are not intended to be limiting. For example, if an embodiment of the present disclosure describes a first feature component formed on or above a second feature component, this may include embodiments where the first feature component is in direct contact with the second feature component, as well as embodiments where additional feature components are formed between the first and second feature components, such that they may not be in direct contact.

It should be noted that additional steps may be performed before, between, or after the described steps of the method, and in other embodiments of the method, some steps may be substituted or omitted.

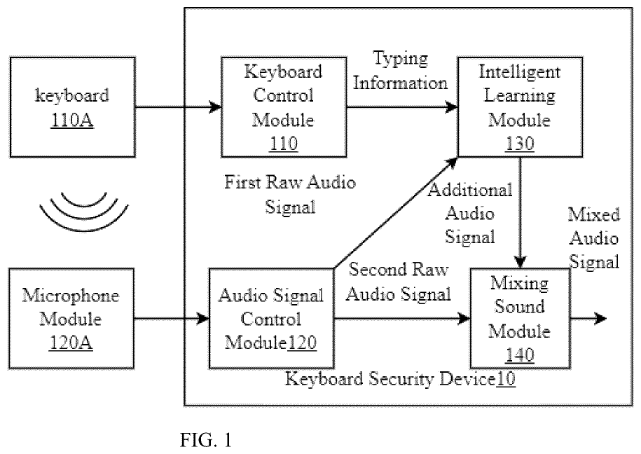

FIG. 1 is a block diagram of a keyboard security device according to an embodiment of the present disclosure. A keyboard security device 10 comprises a keyboard control module 110, an audio signal control module 120, an intelligent learning module 130, and a mixing sound module 140. For example, the keyboard security device 10 may be a portable device (such as a laptop or tablet) or a desktop computer, but the present disclosure is not limited thereto. It should be noted that FIG. 1 illustrates one embodiment of the keyboard security device of the present invention, but the scope of the embodiments of the present invention is not limited thereto. For instance, the keyboard security device of the present invention may not include the keyboard control module and the audio signal control module itself but may instead connect to external keyboard control and audio signal control modules to achieve the solution of the present invention.

The keyboard control module 110 is connected to a keyboard 110A. When the keyboard 110A is in use (e.g., when keys are pressed or released), the keyboard control module 110 is configured to output typing information. For instance, the keyboard 110A may be an external or built-in keyboard. The keyboard control module 110 may be a keyboard controller; however, the present disclosure is not limited to this configuration.

The audio signal control module 120 is connected to a microphone module 120A. When the microphone module 120A is activated, the audio signal control module 120 outputs a first raw audio signal, which corresponds to the typing information. For example, the microphone module 120A may be an external or built-in microphone, capable of capturing/recording sounds including, but not limited to, speech, conversations, and keyboard typing sounds (as represented by the fan-shaped icon in the figure). The audio signal control module 120 may be a digital signal processor (DSP) and may convert the analog signals collected by the microphone module 120A into digital signals; however, the present disclosure is not limited to this configuration.

As described above, the intelligent learning module 130 is connected to the keyboard control module 110 and the audio signal control module 120. The intelligent learning module 130 receives (or inputs) the typing information from the keyboard control module 110 and the first raw audio signal from the audio signal control module 120. Based on this typing information and the first raw audio signal, the intelligent learning module 130 generates an additional audio signal and outputs it. In other words, the intelligent learning module 130 can record/learn the typing sounds corresponding to each keystroke. It can be trained based on the typing information output by the keyboard control module 110 and the raw audio signal from the audio signal control module 120. Once trained, the intelligent learning module 130 can generate and output an additional audio signal based on new typing information from the keyboard control module.

The audio signal control module 120 further outputs a second raw audio signal. For instance, the first raw audio signal may represent previous audio data, while the second raw audio signal may represent current audio data. However, this disclosure is not limited to these examples.

The mixing sound module 140 is connected to the audio signal control module 120 and the intelligent learning module 130. The mixing sound module 140 is configured to receive the second raw audio signal from the audio signal control module 120 and the additional audio signal from the intelligent learning module 130. In response to a trigger signal, the mixing sound module 140 is configured to mix the second raw audio signal and the additional audio signal to generate a hybrid audio signal, and to output the hybrid audio signal. For example, the hybrid audio signal may be output to a recording module or a video module (e.g., software), but the present disclosure is not limited thereto.

That is to say, the additional audio signal generated by the intelligent learning module 130 may act as simulated or artificial typing sounds (rather than pre-recorded sounds), reducing (or even eliminating) regularity, thereby concealing the true length and duration of input information (such as passwords). According to the above, the keyboard security device disclosed herein may perform suitable mixing on the original audio, thereby enhancing the security of using a keyboard while a microphone is active, i.e., reducing (or even eliminating) the potential risk of third parties cracking sensitive information entered by the user by utilizing typing sounds.

In some embodiments, the typing information may include a keypress (make code) event and a key release (or reset) (break code) event of keys in the keyboard 110A, but the present disclosure is not limited thereto. Specifically, the typing information may indicate or record events such as: pressing key “A,” releasing key “A,” pressing key “B,” releasing key “B,” pressing key “C,” pressing key “A,” releasing key “A,” releasing key “C,” and so forth.

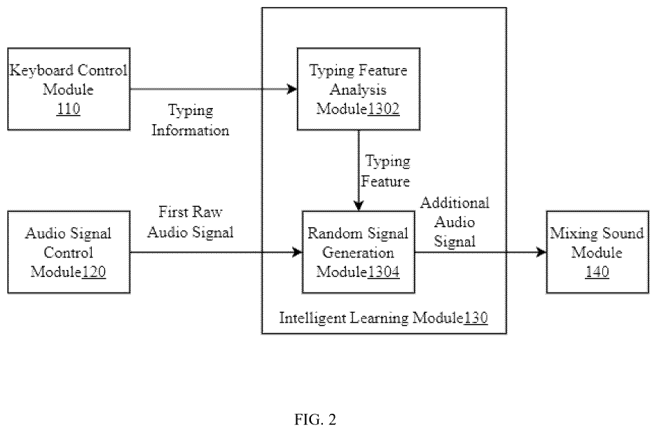

In some embodiments, the intelligent learning module 130 may include a typing feature analysis module 1302 and a random signal generation module 1304, as shown in FIG. 2. FIG. 2 is a block diagram illustrating the intelligent learning module according to an embodiment of the present disclosure. The typing feature analysis module 1302 is configured to receive the typing information from the keyboard control module 110. The typing feature analysis module 1302 is configured to analyze the typing information to generate a typing feature. The random signal generation module 1304 is connected to the audio signal control module 120 and the typing feature analysis module 1302. The random signal generation module 1304 is configured to receive the typing feature from the typing feature analysis module 1302 and the first raw audio signal from the audio signal control module 120. Based on the typing feature and the first raw audio signal, the random signal generation module 1304 is configured to generate the additional audio signal and output the additional audio signal to the mixing sound module 140. For example, the random signal generation module 1304 may be a random pseudo-type sound generator, but the present disclosure is not limited thereto.

In some embodiments, the intelligent learning module 130 may further include a storage module (not shown in the figure). The storage module may be connected to the random signal generation module 1304. The storage module is configured to store the typing feature generated by the typing feature analysis module 1302. For example, the storage module may be a non-volatile memory (NVM), but the present disclosure is not limited thereto.

In some embodiments, the typing feature may include at least one of typing speed, simultaneous pressing of multiple keys, frequency of use for a first key on the keyboard 110A, frequency of use for each key, duration of pressing for a second key, and duration of pressing for each key, but the present disclosure is not limited thereto. For example, through the typing information, the intelligent learning module 130 may learn typing behaviors, including but not limited to typing speed for entering passwords, habits in producing uppercase letters (e.g., pressing Caps Lock first or pressing Shift and a letter simultaneously), and error correction habits (e.g., using arrow keys to move back to the erroneous text before selecting, or directly deleting the incorrect text before retyping the correct text), among others.

In some embodiments, in response to the trigger signal, the intelligent learning module 130 may generate the additional audio signal based on the typing information and the first raw audio signal.

In some embodiments, the trigger signal is generated when a password input area on a human-machine interface is activated. For example, the trigger signal may be generated by a mouse cursor clicking on a password input area or by selecting the password input area through a specific key (such as the auxiliary Tab key), but the present disclosure is not limited thereto.

In some embodiments, the intelligent learning module 130 may be trained using one or more well-known AI learning algorithms or machine learning algorithms, which may include neural networks (e.g., artificial neural networks, deep neural networks, convolutional neural networks (CNN), recurrent neural networks (RNN), autoencoders, reinforcement learning, etc.), fuzzy logic, artificial intelligence (AI), deep learning algorithms, deep structured hierarchical learning algorithms, support vector machines (SVM) (e.g., linear SVM, nonlinear SVM, SVM regression), decision tree learning (e.g., classification and regression trees (CART)), dimensionality reduction algorithms (e.g., projection, manifold learning, principal component analysis, etc.), and/or deep machine learning algorithms.

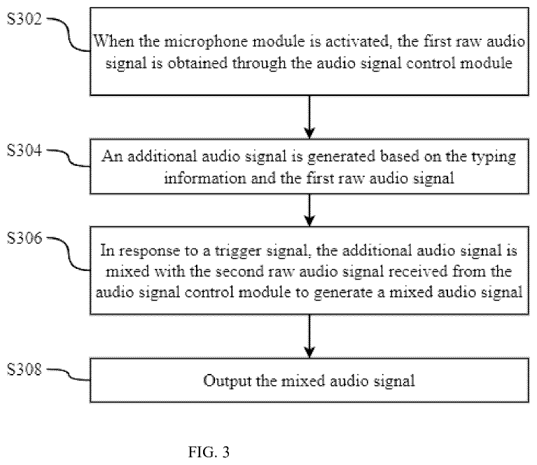

According to the above embodiments, a keyboard security method may be obtained (e.g., summarized as) as follows. FIG. 3 is a flow diagram illustrating the keyboard security method according to an embodiment of the present disclosure. This keyboard security method is applicable in a system including a keyboard, a keyboard control module, a microphone module, and an audio signal control module. The keyboard control module is connected to the keyboard and is configured to output typing information, while the audio signal control module is connected to the microphone module. As shown in FIG. 3, the keyboard security method includes the following steps:

In step S302, when the microphone module is turned on, a first raw audio signal is obtained through the audio signal control module 120, and then step S304 is executed.

In step S304, based on the typing information and the first raw audio signal, an additional audio signal is generated, and then step S306 is executed.

In step S306, in response to a trigger signal, the additional audio signal and a second raw audio signal received from the audio signal control module are mixed to generate a mixed audio signal, and then step S308 is executed.

In step S308, the mixed audio signal is output.

In summary, the keyboard security device and keyboard security method disclosed herein can perform appropriate mixing on the original audio, thereby enhancing the security of using a keyboard while the microphone is active, i.e., reducing (or even eliminating) the potential risk of third parties using typing sounds to crack sensitive information entered by the user.

Although the present application has been disclosed using the above embodiments, it is not intended to limit the disclosure. Any person skilled in the art may make various alterations and modifications to the above embodiments without departing from the spirit and scope of the disclosure, and such alterations and modifications are still within the technical scope protected by the disclosure. Therefore, the scope of protection of the disclosure should be determined by the scope of the claims of the patent application.

What is claimed is:

1. A keyboard security device, comprising:
a keyboard control module, connected to a keyboard and configured to output typing information when the keyboard is in use;
an audio signal control module, connected to a microphone module and configured to output a first raw audio signal when the microphone module is activated, wherein the first raw audio signal corresponds to the typing information;
an intelligent learning module, connected to the keyboard control module and the audio signal control module, and configured to:
generate an additional audio signal based on the typing information received from the keyboard control module and the first raw audio signal received from the audio signal control module; and
output the additional audio signal; and
a mixing sound module, connected to the audio signal control module and the intelligent learning module, and configured to:
in response to a trigger signal, mix a second raw audio signal received from the audio signal control module with the additional audio signal received from the intelligent learning module to generate a mixed audio signal; and
output the mixed audio signal.

2. The keyboard security device according to claim 1, wherein the typing information comprises a key press event and a key release event.

3. The keyboard security device according to claim 1, wherein the intelligent learning module comprises:
a typing feature analysis module configured to:
receive the typing information from the keyboard control module; and,
analyze the typing information to generate a typing feature; and,
a random signal generation module, connected to the audio signal control module and the typing feature analysis module, and configured to:
receive the typing feature from the typing feature analysis module;
receive the first raw audio signal from the audio signal control module;
generate the additional audio signal based on the typing feature and the first raw audio signal; and
output the additional audio signal to the mixing sound module.

4. The keyboard security device according to claim 3, wherein the intelligent learning module further comprises a storage module connected to the random signal generation module and configured to store the typing feature.

5. The keyboard security device according to claim 3, wherein the typing feature comprises at least one of a typing speed, a usage frequency of a first key, a usage frequency and press duration of each of keys of the keyboard, and a press duration of a second key.

6. The keyboard security device according to claim 1, wherein in response to the trigger signal, the intelligent learning module generates the additional audio signal based on the typing information and the first raw audio signal.

7. The keyboard security device according to claim 1, wherein the trigger signal is activated by a password input area on a human-machine interface.

8. A keyboard security device, applied in a system comprising a keyboard, a keyboard control module, a microphone module, and an audio signal control module, wherein the keyboard control module is connected to the keyboard and outputs typing information when the keyboard is in use, the audio signal control module is connected to the microphone module and outputs a raw audio signal when the microphone module is activated, and the raw audio signal corresponds to the typing information, and the keyboard security device comprises:
an intelligent learning module, connected to the keyboard control module and the audio signal control module, wherein the intelligent learning module is trained based on first typing information outputting by the keyboard control module and a first raw audio signal outputted by the audio signal control module, and the trained intelligent learning module generates and outputs an additional audio signal based on second typing information outputted by the keyboard control module; and
a mixing sound module, connected to the audio signal control module and the intelligent learning module, and configured to:
mix a second raw audio signal received from the audio signal control module with the additional audio signal received from the intelligent learning module to generate a mixed audio signal, wherein the second raw audio signal corresponds to the second typing information; and,
output the mixed audio signal.

9. A keyboard security method, applied in a system comprising a keyboard, a keyboard control module, a microphone module, and an audio signal control module, wherein the keyboard control module is connected to the keyboard and configured to output typing information, the audio signal control module is connected to the microphone module, and the keyboard security method comprises:
obtaining a first raw audio signal through the audio signal control module when the microphone module is activated, wherein the first raw audio signal corresponds to the typing information;
generating an additional audio signal based on the typing information and the first raw audio signal;
mixing the additional audio signal with a second raw audio signal received from the audio signal control module in response to a trigger signal to produce a mixed audio signal; and
outputting the mixed audio signal.
